(19) United States
(12) Patent Application Publication
(10) Pub. No.: US 2007/0097687 A1
(43) Pub. Date: May 3, 2007

(54) EMERGENCY LIGHTING DEVICE

(76) Inventor: SANG-JIN MOON, Seoul (KR)

Correspondence Address: IPLA P.A., 3580 WILSHIRE BLVD., 17TH FLOOR, LOS ANGELES, CA, 90010, US

(21) Appl. No.: 11/307,902

(22) Filed: Feb. 27, 2006

(30) Foreign Application Priority Data
Nov. 2, 2005 (KR) 10-2005-0104389

(51) Int. Cl. F21V 23/04

(52) U.S. Cl. 362/276

(57) ABSTRACT

Disclosed herein is an emergency lighting device. The emergency lighting device of the present invention includes a power supply unit, a sensing unit, an output unit, an input unit and an emergency lamp control unit. The present invention provides an emergency lighting device, which uses a remote controller to more easily examine whether auxiliary power is normally supplied, and sets an examination time, thus improving convenience in the use of the emergency lighting device.

### BACKGROUND OF THE INVENTION

1. Field of the Invention

The present invention relates, in general, to emergency lighting devices and, more particularly, to an emergency lighting device, which is installed in a building to provide light when an emergency, such as a fire or power failure, occurs.

2. Description of the Related Art

Generally, an emergency lighting device lights a lamp using a battery provided therein for a certain period of time and allows the direction of an entrance or emergency exit to be easily determined when an emergency, such as a fire or power failure, occurs in a multistoried building, a public office, a sports stadium or a concert hall.

Such conventional emergency lighting device is constructed to allow a fire manager to monitor the operating status of equipment in real time. However, since the emergency lighting device is installed to be adjacent to the ceiling of a building, it is inconvenient to manage the emergency lighting device using a manual switch, and since the emergency lighting device only functions as a typical lamp, it is incapable of actively responding to emergencies.

### SUMMARY OF THE INVENTION

Accordingly, the present invention has been made keeping in mind the above problems occurring in the prior art, and an object of the present invention is to provide an emergency lighting device, which can easily determine the charging status of auxiliary power and the operating status of a lamp, and provide integrated functionality incremental to a typical lamp function, thus minimizing the loss of lives and property when a disaster or a fire occurs.

Other objects and advantages of the present invention will be more clearly described and understood from the embodiments of the present invention. The objects and advantages of the present invention can be realized by means and combinations disclosed in the accompanying claims.

In order to accomplish the above object, the present invention provides an emergency lighting device, comprising a power supply unit for supplying main power and auxiliary power; a sensing unit for sensing occurrence of an emergency at a location where the emergency lighting device is installed, using temperature and illuminance; an output unit including at least one emergency lamp for lighting a lamp provided therein in response to a signal output from the sensing unit; an input unit including a remote controller for receiving a command required to interrupt supply of the main power and to examine status of supply of the auxiliary power; and an emergency lamp control unit for controlling operation of the power supply unit, the sensing unit, the output unit and the input unit.

Preferably, the remote controller may have a function of setting an examination time.

Preferably, the output unit may further comprise a radio transmitter for outputting a radio broadcast at a preset frequency through a speaker when an emergency occurs.

Preferably, the emergency lamp control unit may transmit information indicating occurrence of an emergency to a center control unit for managing and controlling an entire building, and the input unit may further comprise a rescue button for transmitting a rescue signal to the center control unit through the emergency lamp control unit when an emergency occurs.

### BRIEF DESCRIPTION OF THE DRAWINGS

The above and other objects, features and other advantages of the present invention will be more clearly understood from the following detailed description taken in conjunction with the accompanying drawings, in which:

FIG. 1 is a perspective view of an emergency lighting device according to an embodiment of the present invention; and

FIG. 2 is a block diagram schematically showing the emergency lighting device of FIG. 1.

### DESCRIPTION OF THE PREFERRED EMBODIMENTS

Hereinafter, embodiments of the present invention will be described in detail with reference to the attached drawings. Prior to the description thereof, the terms and words used in the present specification and claims should not be interpreted as being limited to their typical meaning based on the dictionary definitions thereof, but should be interpreted to have the meaning and concept relevant to the technical spirit of the present invention, based on the fundamental notion that the present inventor can suitably define the concept of the terms to describe the invention using the best method.

Therefore, the constructions in the embodiments described in the present specification and in the drawings are only preferred embodiments of the present invention, and do not define the entire technical spirit of the present invention. Therefore, those skilled in the art will understand that various equivalents and modifications capable of replacing the constructions at the time of filing the present invention.

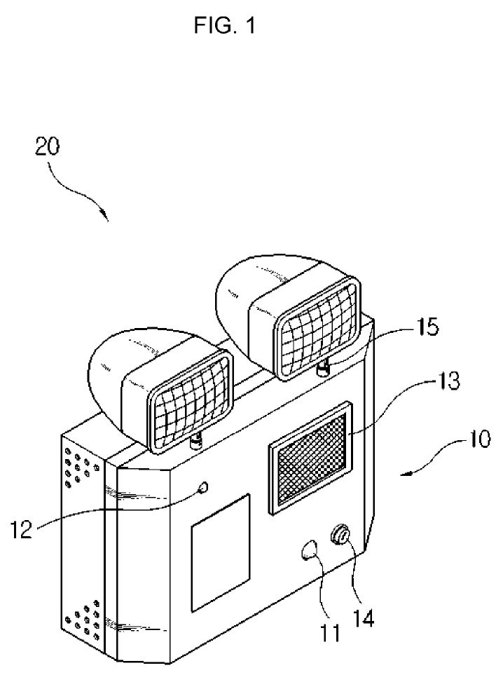

FIG. 1 is a perspective view of an emergency lighting device according to an embodiment of the present invention. The emergency lighting device according to a preferred embodiment of the present invention includes a control box 10 that has a rear surface supportable on a wall and is made of a metallic material. Further, in the control box 10, a fire sensor 11, a Light Emitting Diode (LED) 12 for indicating whether power is supplied, a speaker 13 for outputting a radio broadcast, and a rescue button 14 are provided.

The present invention can be described in that, for the fire sensor 11, a temperature sensing unit for sensing heat and an illuminance sensing unit for sensing light are used. Further, a smoke sensing unit for sensing smoke can also be used for the fire sensor 11.

Further, emergency lamps 20 installed in the emergency lighting device of the present invention are connected to the control box 10 through connecting holes 15 and the direction of the emergency lamps 20 can be horizontally or vertically adjusted. Each of the emergency lamps 20 includes therein a lamp lit by power. As the lamp for each emergency lamp 20, an incandescent or florescent lamp can be used. Preferably, the external surface of the emergency lamp 20 is covered with a heat-resistant glass cover to provide protection from fire, etc.

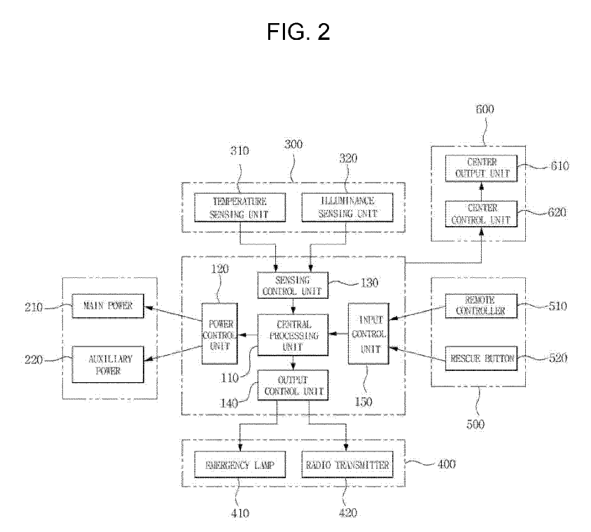

FIG. 2 is a block diagram schematically showing the emergency lighting device of FIG. 1. As shown in FIG. 1, the emergency lighting device of the present invention includes a power supply unit 200 for supplying main power 210 and auxiliary power 220, a sensing unit 300 for sensing the occurrence of an emergency at the location where the emergency lighting device is installed, using temperature and illuminance, an output unit 400 including at least one emergency lamp 410 for lighting a lamp provided therein in response to a signal output from the sensing unit 300, an input unit 500 including a remote controller 510 for receiving a command required to interrupt the supply of the main power 210 and to examine the status of the supply of auxiliary power 220, and an emergency lamp control unit 100 for controlling the operation of the power supply unit 200, the sensing unit 300, the output unit 400 and the input unit 500.

The main power 210 of the power supply unit 200 is used to supply power under normal conditions and the auxiliary power 220 is used to ensure the continuous supply of power even when the supply of the main power 210 is interrupted in an emergency.

The sensing unit 300 is provided with a temperature sensing unit 310 and an illuminance sensing unit 320 to sense the temperature and illuminance of the place where the emergency lighting device is installed, thus allowing the emergency lamp control unit 100 to determine whether an emergency occurs.

The output unit 400 further includes a radio transmitter 420 for outputting a radio broadcast at a preset frequency through a speaker 15 while lighting the emergency lamp 410 if an emergency occurs. A person, evacuating in the event of the emergency, can understand the external situation by listening to the radio broadcast from the radio transmitter 420, remain calm, and then try to find an escape route for himself or herself when the person is isolated in a building or a similar space.

The remote controller 510 of the input unit 500 can simultaneously examine a plurality of emergency lamps using the same frequency through a single manipulation. Further, the remote controller 510 has the function of setting an examination time and can be used as a typical watch when the remote controller 510 is not used.

Further, the emergency lamp control unit 100 transmits information indicating the occurrence of an emergency, etc. to a center control unit 610 for managing and controlling an entire building. The input unit 500 further includes a rescue button 520 which transmits a rescue signal to the center control unit 610 through the emergency lamp control unit 100 when an emergency occurs. Therefore, an evacuating person can press the rescue button 520 to notify outside parties of his or her location when the person is isolated, and can be quickly rescued from the emergency. In this case, the center control unit 610 is installed in a center management unit 600 for managing the entire building. The center management unit 600 includes a center output unit 620 capable of outputting information transmitted from the emergency lamp control unit 100, thus detecting the location of an evacuating person in the building.

The emergency lamp control unit 100 also includes a central processing unit 110, and further, a power control unit 120, a sensing control unit 130, an output control unit 140 and an input control unit 150 for controlling the power supply unit 200, the sensing unit 300, the output unit 400 and the input unit 500, respectively.

As described above, the present invention provides an emergency lighting device, which uses a remote controller to more easily examine whether auxiliary power is normally supplied, and sets an examination time, thus improving convenience in the use of the emergency lighting device.

Further, the present invention is advantageous in that when an emergency occurs, an external situation can be understood through radio broadcasts, and information about the location of an evacuating person can be externally provided using a rescue button, thus improving a rescue function.

Although the preferred embodiments of the present invention have been disclosed for illustrative purposes, those skilled in the art will appreciate that various modifications, additions and substitutions are possible, without departing from the scope and spirit of the invention as disclosed in the accompanying claims.

What is claimed is:

1. An emergency lighting device, comprising:
a power supply unit for supplying main power and auxiliary power;
a sensing unit for sensing occurrence of an emergency at a location where the emergency lighting device is installed, using temperature and illuminance;
an output unit including at least one emergency lamp for lighting a lamp provided therein in response to a signal output from the sensing unit;
an input unit including a remote controller for receiving a command required to interrupt supply of the main power and to examine status of supply of the auxiliary power; and
an emergency lamp control unit for controlling operation of the power supply unit, the sensing unit, the output unit and the input unit.

2. The emergency lighting device according to claim 1, wherein the remote controller has a function of setting an examination time.

3. The emergency lighting device according to claim 1, wherein the output unit further comprises a radio transmitter for outputting a radio broadcast at a preset frequency through a speaker when an emergency occurs.

4. The emergency lighting device according to claim 1, wherein:
the emergency lamp control unit transmits information indicating occurrence of an emergency to a center control unit for managing and controlling an entire building, and the input unit further comprises a rescue button for transmitting a rescue signal to the center control unit through the emergency lamp control unit when an emergency occurs.
